(19) United States
(12) Patent Application Publication
(10) Pub. No.: US 2009/0228447 A1
(43) Pub. Date: Sep. 10, 2009

(54) System, method, and solfware application for enabling a user to search an external domain within a visual mapping interface

(76) Inventors: William J. Creekbaum, San Mateo, CA (US); Michael B. Jetter, Corte Madera, CA (US); Steven Bashford, Aschaffenburg (DE)

Correspondence Address: Tina M. Lessani;Lessani & Lessani LLP, 163 Cypress Point Road, Half Bay Moon, CA, 94019, US

(21) Appl. No.: 12/291,496

(22) Filed: Nov. 10, 2008

Related U.S. Application Data
(63) Continuation-in-part of application No. 10/882,556, filed on Jul. 1, 2004.

(51) Int. Cl. G06F 17/30

(52) U.S. Cl. 707/3; 707/E17.108; 715/769; 715/764; 715/810

(57) ABSTRACT

The present invention provides a system, method, and software application for enabling a user to initiate a search of a domain and view search results via a visual mapping interface on a computer. Visual mapping software on a computer provides a visual mapping interface into which a user can enter one or more search terms. The search terms entered by the user are used to search a search domain, such as an external website. Within the visual mapping interface, the visual mapping software provides the user with one or more search domain options, and the user selects a search domain. After the user enters search terms into the visual mapping interface and selects a search domain, the visual mapping software initiates a search of the selected domain based on the search terms. The visual mapping software subsequently receives search results for the search, and displays the search results in a visual map.

### RELATED APPLICATIONS

This application is a continuation-in-part of U.S. patent application Ser. No. 10/882,556 titled “System and Method for Graphically Illustrating External Data Source Information in the Form of a Visual Hierarchy in an Electronic Workspace,” which was filed on Jul. 1, 2004 and which is incorporated by reference as if fully disclosed herein.

### BACKGROUND OF THE INVENTION

1. Field of the Invention

This invention relates generally to visual mapping systems, and, more particularly, to enabling a user to search an external domain within a visual mapping interface.

2. Description of the Background Art

The Internet and the World Wide Web (the “Web”) have made a wealth of information available to Internet users. Users can use search engines, such as GOOGLE, MSN, and YAHOO to search the Web. Also, some e-commerce sites such as EBAY and AMAZON.COM enable users to search a vast inventory of products.

Visual maps, such as mind maps and topics maps, provide an excellent way for users to view large amounts information in an organized, graphical format. A visual map is a diagram that represents ideas and/or information in topics. Examples of visual maps are mind maps, topic maps, semantic networks, and concept maps. Visual maps are increasingly used to help people generate, classify, and/or organize ideas and information and to see such ideas and information in a hierarchical, visual layout. Visual maps are used for project management, work-flow analysis, organizational charts, and other purposes.

FIG. 1 is an example of a visual map for information related to a wireless communication project meeting. The visual map in FIG. 1 is a mind map. Mind maps are made up of hierarchically-arranged topics. The main topics in FIG. 1 are “Action Items”, “Purpose”, “Agenda”, “Time Place”, “Participants”, and “Purpose.” Each of these topics has subtopics. For instance, “Implementation” is a subtopic for “Action Items,” and “Carry out Launch” is a subtopic of “Implementation.” Users typically create topics in a visual map by inserting or importing text and graphic elements into topics.

Users typically create visual maps using proprietary visual mapping software. Mindjet LLC's MINDMANGER® and MINDJET CONNECT are examples of such software.

A visual map is an excellent way to display search results, especially from large search domains, such as Internet search engines (e.g., GOOGLE, YAHOO). While existing visual mapping systems can import data from external sources into a visual map, there is currently no known method for enabling a user to initiate a search of an external website from a visual map and view the search results within a visual map interface. Therefore, there is a need for a visual map interface from which a user can initiate a search of an external website.

### SUMMARY

The present invention provides a system, method, and software application for enabling a user to initiate a search and view search results via a visual mapping interface on a computer. Visual mapping software on a computer provides a visual mapping interface into which a user can enter one or more search terms. The user may enter search terms into a topic in a visual map, or he/she may enter search terms into a dialog box or other field within the visual mapping interface.

The search terms entered by the user are used to search a search domain. Within the visual mapping interface, the visual mapping software provides the user with one or more search domain options, and the user selects a search domain. Examples of search domain options include Web search engines, such as GOOGLE, YAHOO, and MSN; e-commerce websites, such as EBAY and AMAZON.COM; and social/business networking websites, such as FACEBOOK, MYSPACE.COM, and LINKEDIN.

After the user enters search terms into the visual mapping interface and selects a search domain, the visual mapping software initiates a search of the selected domain based on the search terms. For example, the visual mapping software can make a call to a Web service associated with the selected domain, where the call includes a request to perform a search based on the search terms. After the visual mapping software initiates a search of the selected domain, the visual mapping software subsequently receives search results for the search, and displays the search results in a visual map. Multiple searches (of the same or different search domains) can be initiated and displayed within a single visual map.

### BRIEF DESCRIPTION OF THE DRAWINGS

FIG. 1 is an example of a mind map.

FIG. 2 is a flowchart that illustrates a method, according to one embodiment of the present invention, for enabling a user to initiate a search and view search results via a visual mapping interface on a computer.

FIG. 3 is a flowchart that illustrates an example of one way in which the method of FIG. 2 can be implemented.

FIG. 4 illustrates an outline of a Web service definition.

FIG. 5 is a block diagram that illustrates an example visual mapping system.

FIGS. 6a-6e are screen shots of a visual mapping interface, wherein the screen shots illustrate an example implementation of the present invention.

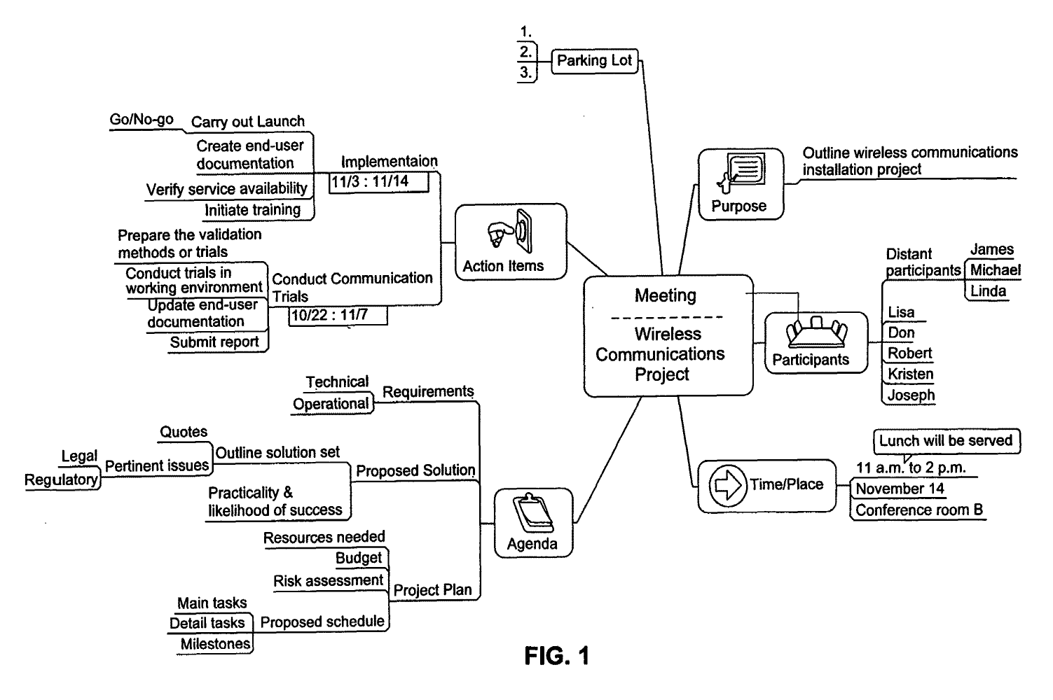

### DETAILED DESCRIPTION OF THE PREFERRED EMBODIMENTS

The present invention provides a system, method, and software application for enabling a user to initiate a search and view search results via a visual mapping interface on a computer. A user can initiate a search on one or more external sites via a visual map interface and then view the search results in a visual map.

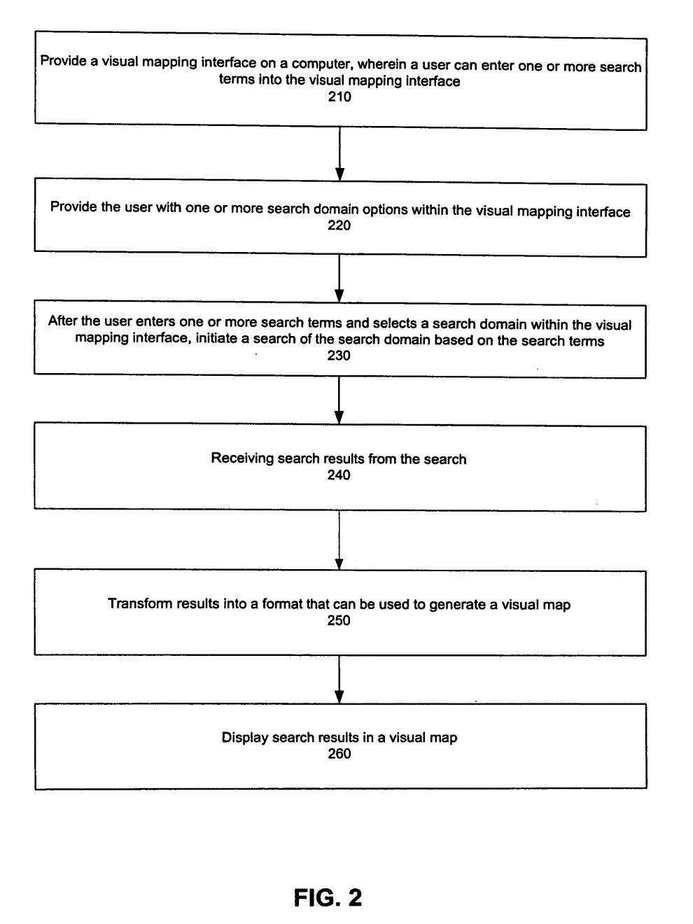

FIG. 2 illustrates a method according to one embodiment of the present invention. The method is implemented by visual mapping software running on a client computer (including, but not limited to web browser-based applications) or a server computer. As stated above, Mindjet LLC's MINDMANAGER and MINDJET CONNECT software are examples of visual mapping software.

Referring to FIG. 2, visual mapping software on a computer provides a visual mapping interface into which a user can enter one or more search terms (step 210). A visual mapping interface is an interface in which a visual map can be created, edited, or displayed. The user may enter search terms into a topic in a visual map, or he/she may enter search terms into a dialog box or other field within the visual mapping interface.

The search terms entered by the user are used to search a search domain. Within the visual mapping interface, the visual mapping software provides the user with one or more search domain options (220). In the preferred embodiment, search domains are any domain associated with a web service. Examples of search domain options include Web search engines, such as GOOGLE, YAHOO, and MSN; e-commerce websites, such as EBAY and AMAZON.COM; and social/business networking websites, such as FACEBOOK, MYSPACE.COM, and LINKEDIN. There are multiple ways in which a user can select a search domain. For example, a user may click on an icon representing a search domain.

After the user enters search terms into the visual mapping interface and selects a search domain, the visual mapping software initiates a search of the domain based on the search terms (230). For example, the visual mapping software can make a call to a Web service associated with the search domain, where the call includes a request to perform a search based on the search terms.

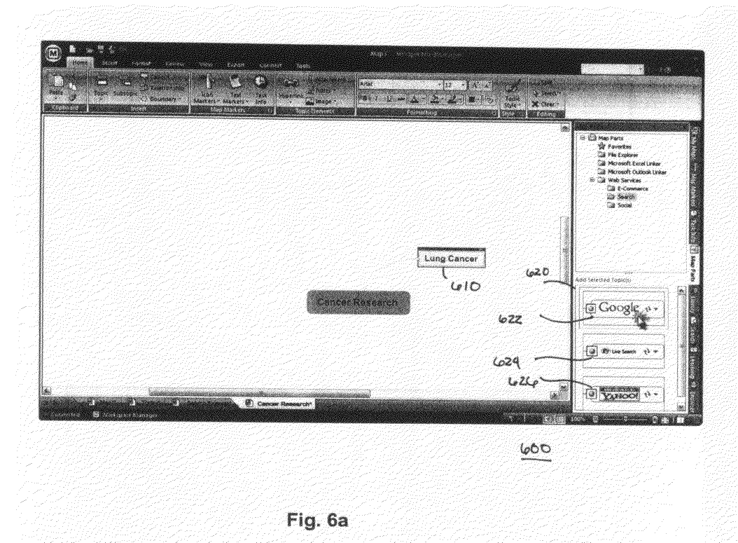

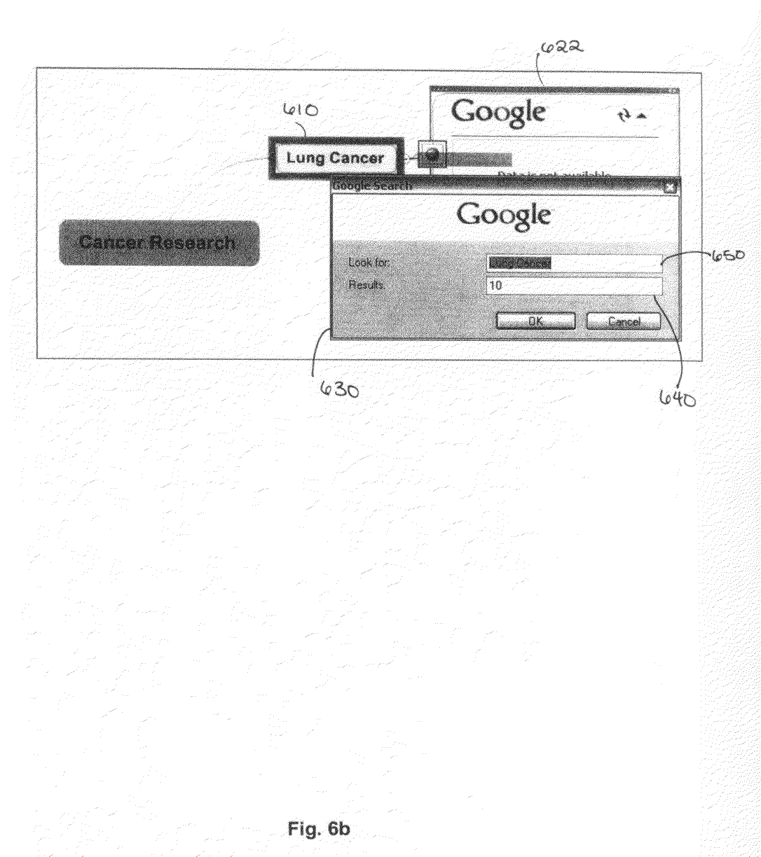

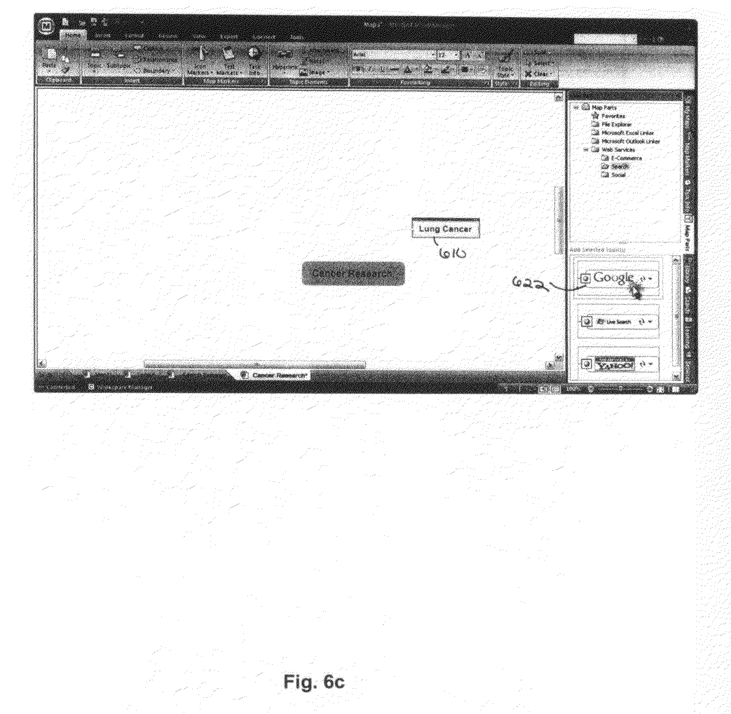

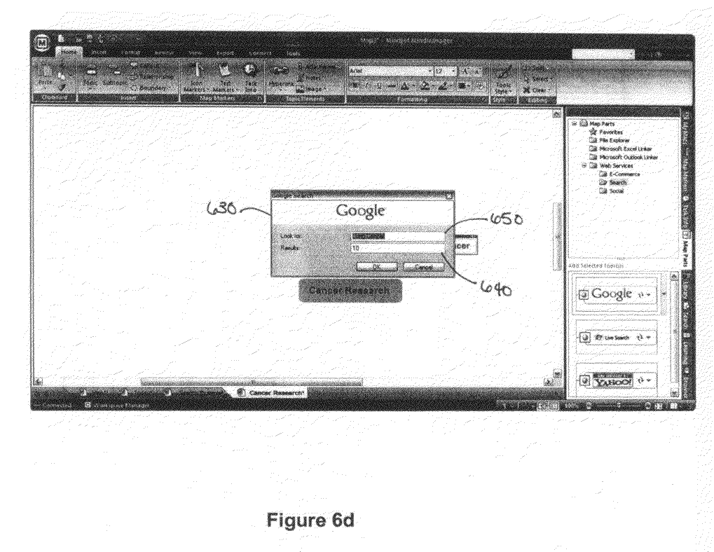

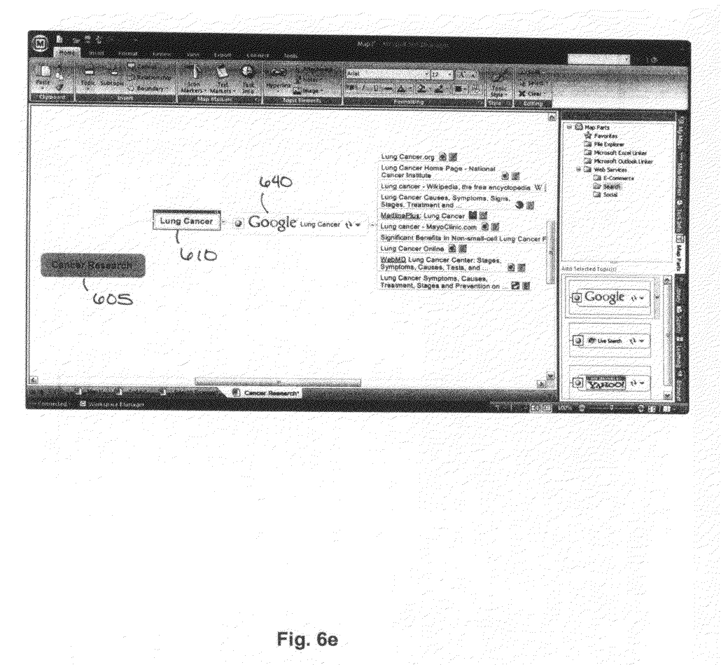

After the visual mapping software initiates a search of the search domain, the visual mapping software subsequently receives search results for the search (step 240) and transforms the received data into a format that can be used by the visual mapping software to generate a visual map (step 250). The visual mapping software then displays the search results in a visual map (step 260). In one embodiment, the displayed map includes a topic that illustrates the search domain used, and the search results are displayed as subtopics to such topic (see FIG. 6e).

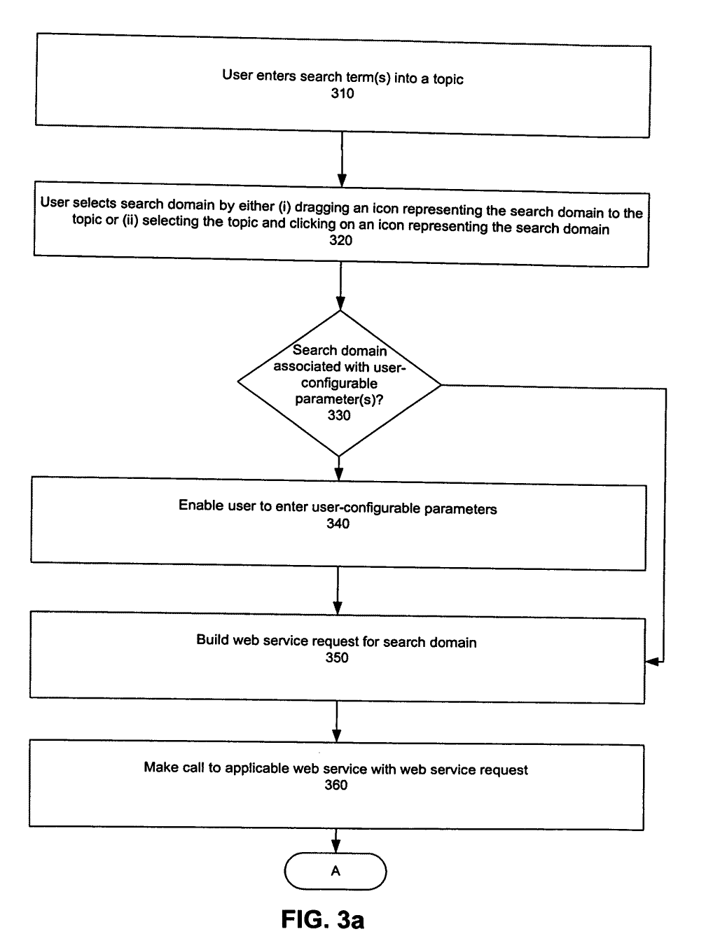

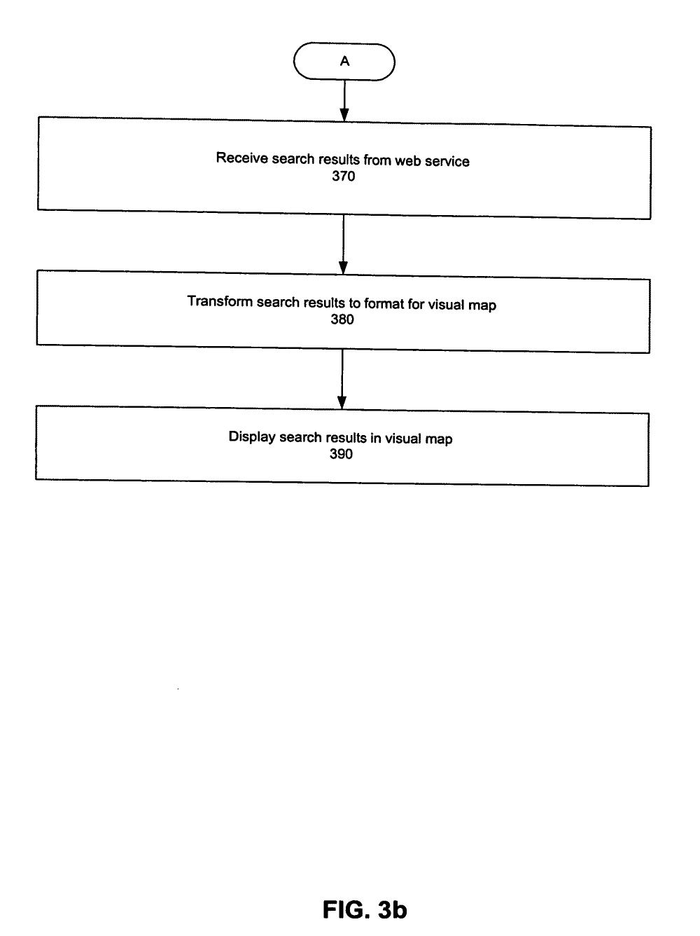

FIGS. 3, 4, and 6a-6e together illustrate an example implementation of the method described in FIG. 2. There may be other ways to implement the method of FIG. 2, and the invention is not limited to this example implementation.

Referring to FIG. 3, a user enters search terms into a topic (step 310). An example of this can be seen in FIG. 6a, where a user has typed “Lung Cancer” into topic 610 in visual map interface 600.

A list of search domain options is displayed in window 620 in FIG. 6a. Specifically, window 620 includes GOOGLE icon 622, MSN LIVE SEARCH icon 624, and YAHOO icon 626.

In the present example, the user selects a search domain by either (i) dragging an icon representing a search domain to the topic or (ii) selecting the topic and clicking on an icon representing the search domain (step 320). In FIG. 6b, a user had dragged the GOOGLE icon 622 to topic 610. Alternately, in FIG. 6c, a user has selected topic 610 and clicked on the GOOGLE icon 622.

After the user selects a search domain, the visual mapping software determines whether or not the search domain is associated with any user-configurable parameters (step 340). If so, the visual mapping software enables the user to enter user-configurable parameters (step 340). In one embodiment, the visual mapping software provides a dialog box or form into which user can enter user-configurable search parameters.

In the example of FIGS. 6a-6e, the number of search results displayed is a user-configurable parameter. When a user selects the GOOGLE search domain, a dialog box 630 appears (FIGS. 6b and 6d). The dialog box 630 includes a “Results” field 640 into which a user can specify the number of search results he/she wants to see in the visual map. A default parameter may initially be displayed in field 640. The dialog box 630 also includes a search terms field 650 (i.e., the “Look for” field). In this example, the default entry for search terms field 650 is “Lung Cancer,” as these are the terms entered into topic 610. Dialog box 630 gives the user the opportunity to change the search terms.

In the present example, each of the search domains is associated with a Web service. A Web service is a service made available from an entity's web server and accessible on the World Wide Web via the Internet. A computer can make a call to a Web service based on the Web service's published API (application programming interface). A Web service associated with a search domain is a service that provides search results from the search domain. For example, a GOOGLE Web service provides GOOGLE search results.

After a user has selected a search domain and entered any user-configurable parameters, the visual mapping software builds a Web service request for the Web service associated with the selected search domain (step 350).

If the user has entered user-configurable parameters for the search, the Web service request includes the user-configurable parameters, as well as any default parameters associated with the selected search domain. If there are no user-configurable parameters, then the Web service request includes default parameters (if any).

After building a Web service request, the visual mapping application makes a call to the applicable Web service with the Web service request (step 360). The visual mapping application subsequently receives search results from the Web service (step 370). The visual mapping software transforms the result data obtained from the Web service into a format applicable to visual maps (step 380). For example, it is common for Web service results to be in the form of XML. The visual mapping application can then perform an XSLT transformation on the result data to transform it into an XML format from which a visual map can be generated. The visual mapping software then displays the search results in a visual map (step 390). FIG. 6e illustrates the results (limited to 10 per the dialog box shown in FIGS. 6b and 6c) from a Google search of “Lung Cancer” displayed in a visual map.

The visual map in FIG. 6e includes a topic 640 that indicates that GOOGLE was the search domain associated with the search results displayed. In this example, topic 640 was added as a subtopic to topic 610 in response to the user selecting GOOGLE as the search domain. Topic 640 is referred to herein as a “search map part.” By displaying search map parts in the map, a user viewing the map can see where the search was performed. This can be helpful if the user viewing the map was not the user who created the map and performed the search. Also, if multiple searches are performed, a user can easily see the search results associated with each domain.

Search map parts can be added at any level of the map. For example, a search map part can be added as a subtopic to (i) the main topic “Cancer Research” 605, (ii) the “Lung Cancer” topic 610, or (iii) any of the search results displayed in FIG. 6e. In one embodiment a search map part is a type of content-specific topic, where one of the properties of the topics is that is able to perform the method of FIG. 3 (e.g., software code capable of performing the method of FIG. 3 is compiled into the topic). A content-specific topic is designed specifically for a type of content. One implementation of content-specific topics are described in U.S. patent application Ser. No. 11/478,220, titled “System and Method for Providing Content-Specific Topics in a Mind Mapping System,” and filed on Jun. 29, 2006, the contents of which are incorporated by reference as if fully described herein.

In one embodiment, when a user selects a search domain, the visual mapping software retrieves a Web service “definition” for the search domain. A Web services “definition” specifies (i) the parameters associated with the web service request, (ii) the requirements for building a web service request, and (iii) instructions on how to handle and transform the data returned from the web service request.

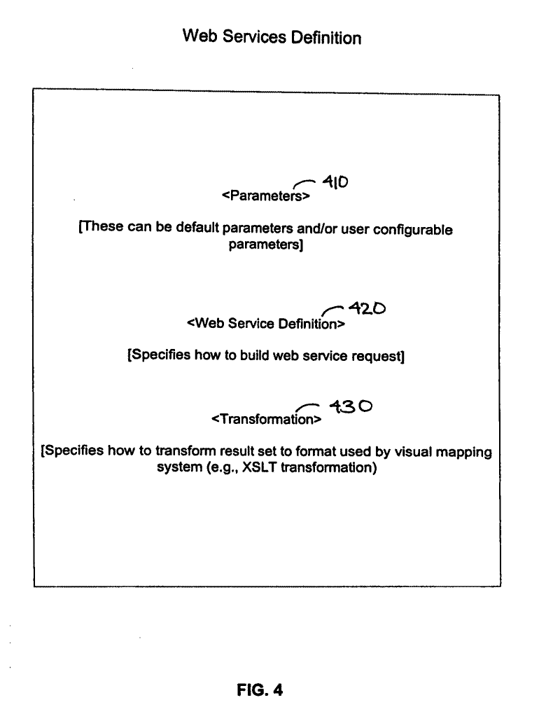

FIG. 4 illustrates an example outline of a Web services definition. The definition includes a Parameters section 410 that specifies any default parameters or user-configured parameters that are included in a Web service requests. The Web Service Definition section 420 specifies how to build a Web service request for the particular Web service associate with the definition. The Transformation section 430 specifies how to transform data received from the Web service to a data format used by the visual mapping system. In the preferred embodiment, the data from a Web services is in XML format, and the transformation is a XSLT transformation that transforms the XML data from the Web Service into an XML format used by the visual mapping software. In one embodiment, a web service definition is an XML file that is compiled into a search map part.

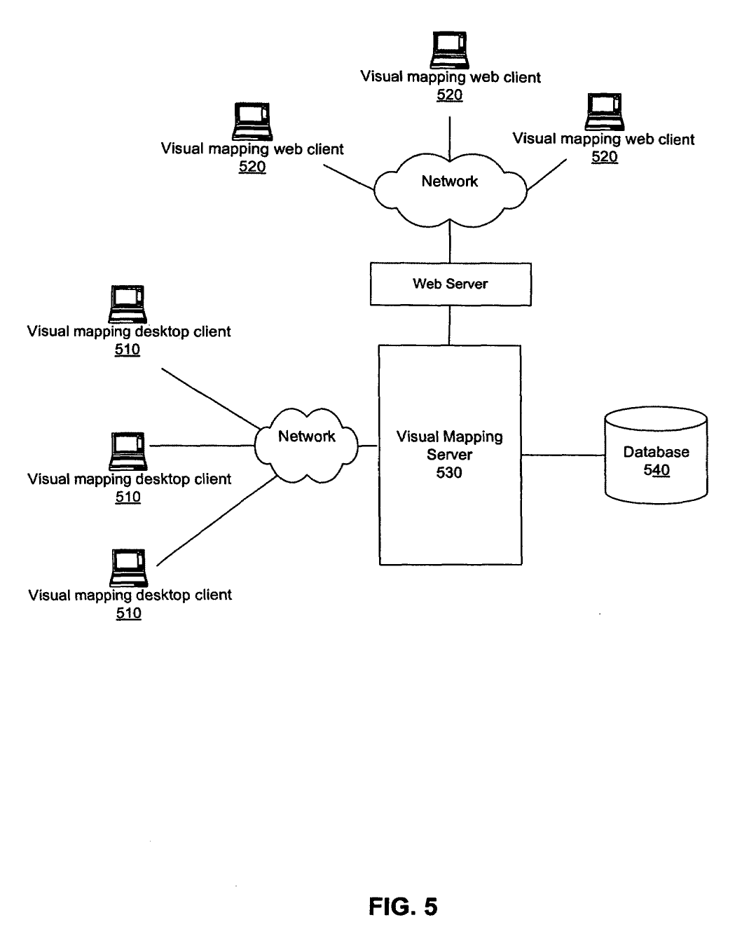

FIG. 5 illustrates an example of a visual mapping system 500 in which the present invention can be implemented. Visual mapping system 500 is only an example, and the invention is not limited to this example.

In system 500, a user can create visual map from a visual mapping desktop client 510 or a visual mapping web client 520. These visual mapping clients 510, 520 are served by a visual mapping server 530. Mindjet LLC's MINDJET CONNECT is an example of a visual mapping server application. After a user creates or edits a visual map, the visual mapping client (510 or 520) sends the map data to the visual mapping server 530, which stores the data in a file system or a database 540. Visual maps with search results can be saved and shared with other users. In one embodiment, search results are refreshed when a map with a search map part is opened (i.e., a search is performed each time the map is opened).

A visual map can be stored as a file, or the topics in a map can be stored in individually in a database, as described in U.S. patent application Ser. No. 12/001,533 titled “System and Method for Enabling a User to Search and Retrieve Individual Topics in a Visual Mapping System,” which was filed on Dec. 12, 2007 and which is incorporated by reference as if fully disclosed herein.

The method of FIGS. 2 and 3 can be implemented by the visual mapping client (510 or 520) in conjunction with the visual mapping server 530. The method of FIGS. 2 and 3 can also be implemented by visual mapping software running in an external application, such as the visual mapping software with the network module described in the U.S. patent application titled “System, Method, and Software Application for Enabling a User to View and Interact with a Visual Map in a Non-Visual Mapping Application,” filed on Nov. 10, 2008, and having inventors Neil S. Mendelson, William J. Creekbaum, and Andriy O. Mochalskyy, the content of which are incorporated by reference herein.

As will be understood by those familiar with the art, the invention may be embodied in other specific forms without departing from the spirit or essential characteristics thereof. Accordingly, the above disclosure of the present invention is intended to be illustrative and not limiting of the invention.

1. A method for enabling a user to search a domain within a visual mapping interface on a computer, the method comprising:
providing a visual mapping interface on a computer, wherein a user can enter one or more search terms into the visual mapping interface;
providing the user with one or more search domain options within the visual mapping interface;
in response to the user entering one or more search terms and selecting a search domain within the visual mapping interface, initiating a search of the search domain based on the search terms;
receiving search results from the search; and
displaying the search results in a visual map.

2. The method of claim 1, wherein the search terms are entered in a topic in the visual map, and the search results are displayed as subtopics to such topic.

3. The method of claim 1, wherein initiating a search comprises making a call to a Web service associated with the search domain.

4. The method of claim 3, further comprising transforming search results from the Web service into a format that can be used to display a visual map.

5. The method of claim 1, wherein providing the user with one or more search domain options comprises providing the user with the ability to select one or more Web search engines for performing the search.

6. The method of claim 5, wherein one of the search engines is GOOGLE.

7. The method of claim 5, wherein one of the search engines is YAHOO.

8. The method of claim 5, wherein one of the search engines is MSN.

9. The method of claim 1, wherein providing the user with one or more search domain options comprises providing the user with the ability to select one or more websites on which to perform the search.

10. The method of claim 9, wherein one of the websites is EBAY.

11. The method of claim 9, wherein one of the websites is AMAZON.COM.

12. The method of claim 1, wherein the user enters search terms into a topic in a visual map, and wherein a user selects a search option by dragging an icon representing a search domain to the topic with the search terms.

13. The method of claim 1, wherein the user enters search terms into a topic in a visual map, and wherein a user selects a search option by selecting the topic and then selecting an icon representing a search domain.

14. The method of claim 1, wherein the search results are displayed as subtopics to the topic with the search terms.

15. The method of claim 1, wherein providing the user with one or more search domain options comprises displaying an icon associated with each search domain option.

16. The method of claim 1, wherein providing the user with one or more search domain options comprises displaying a list of search domain options.

17. The method of claim 1, wherein:
in response to a user selecting a search domain and prior to initiating a search of the search domain, determining if there are any user-defined parameters associated with such search domain; and
in response to determining that there are user-defined parameters associated with such search domain, prompting the user to enter the user-defined parameters.

18. A computer program embodied on a computer-readable medium and comprising code, that, when executed by a computer, enables the computer to perform the following method:
providing a visual mapping interface on the computer, wherein a user can enter one or more search terms into the visual mapping interface;
providing the user with one or more search domain options within the visual mapping interface;
in response to the user entering one or more search terms and selecting a search domain within the visual mapping interface, initiating a search of the search domain based on the search terms;
receiving search results from the search; and
displaying the search results in a visual map.

19. The computer program of claim 18, wherein the search terms are entered in a topic in the visual map, and the search results are displayed as subtopics to such topic.

20. The computer program of claim 18, wherein initiating a search comprises making a call to a Web service associated with the search domain.

21. The computer program of claim 20, further comprising transforming search results from the Web service into a format that can be used to display a visual map.

22. The computer program of claim 18, wherein providing the user with one or more search domain options comprises providing the user with the ability to select one or more Web search engines for performing the search.

23. The computer program of claim 22, wherein one of the search engines is GOOGLE.

24. The computer program of claim 22, wherein one of the search engines is YAHOO.

25. The computer program of claim 22, wherein one of the search engines is MSN.

26. The computer program of claim 18, wherein providing the user with one or more search domain options comprises providing the user with the ability to select one or more websites on which to perform the search.

27. The computer program of claim 26, wherein one of the websites is EBAY.

28. The computer of claim 26, wherein one of the websites is AMAZON.COM.

29. The computer program of claim 18, wherein the user enters search terms into a topic in a visual map, and wherein a user selects a search option by dragging an icon representing a search domain to the topic with the search terms.

30. The computer program of claim 18, wherein the user enters search terms into a topic in a visual map, and wherein a user selects a search option by selecting the topic and then selecting an icon representing a search domain.

31. The computer program of claim 18, wherein the search results are displayed as subtopics to the topic with the search terms.

32. The computer program of claim 18, wherein providing the user with one or more search domain options comprises displaying an icon associated with each search domain option.

33. The computer program of claim 18, wherein providing the user with one or more search domain options comprises displaying a list of search domain options.

34. The computer program of claim 18, wherein:
in response to a user selecting a search domain and prior to initiating a search of the search domain, determining if there are any user-defined parameters associated with such search domain; and
in response to determining that there are user-defined parameters associated with such search domain, prompting the user to enter the user-defined parameters.

35. The method of claim 1, wherein one of the search domain options in a social networking website.

36. The computer program of claim 18, wherein one of the search domain options is a social networking website.
